(19) United States
(12) Patent Application Publication
(10) Pub. No.: US 2005/0285501 A1
(43) Pub. Date: Dec. 29, 2005

(54) Cathodoluminescent gas discharge display

(75) Inventors: Ramon Pascal Van Gorkom, Eindhoven (NL); Roy Van Dijk, Eindhoven (NL); Siebe Tjerk De Zwart, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 10/519,053

(22) PCT Filed: Jun. 13, 2003
(86) PCT No.: PCT/IB03/02865

§ 371 Date: Dec. 22, 2004

(30) Foreign Application Priority Data
Jul. 1, 2002 (EP) 02077607.6

(51) Int. Cl. H01J 1/62

(52) U.S. Cl. 313/485

(57) ABSTRACT

The invention relates to a cathodoluminescent gas discharge display having a reversed plasma direction, wherein secondary electrons (e−) generated by the impact of plasma ions (I+) on a cathode (5) are used to excite a luminescent substance (6). An advantage of the invention is that the ion feedback flow is reduced, which implies the application of a higher acceleration voltage and consequently a higher luminous efficacy.

The present invention relates to a cathodoluminescent gas discharge display.

Within the field of display devices, the demand for high-quality large screens, such as television (TV) and computer screens, has increased in recent years. Cathode ray tubes (CRT) have been widely used as TV displays and, in general, they still produce the highest quality image among all kinds of display devices available on the market. However, as the depth and weight of a CRT increase with an increase of the screen size, a CRT, which has a rather huge bulk, is not suitable for large screen sizes, such as screens exceeding 40 inches. Thus, flat panel displays, such as liquid crystal displays (LCD), plasma display panels (PDP) and field emission displays (FED), are used for the production of such large screens.

PDPs are divided into two subgroups, direct current (DC) and alternating current (AC) PDPs.

Basically, a PDP comprises a gas-filled space defined by a front panel and opposite thereto a rear panel. Barrier ribs are provided on the rear panel to provide an internal vacuum support. A fluorescent screen is disposed on the rear panel and on the sides of the barrier ribs facing the gas-filled space. A cathode, an anode and addressing electrodes are arranged on either the front panel or the rear panel. The gas-filled space comprises an atmosphere of a discharge gas, such as a noble gas, e.g. helium (He), xenon (Xe), or neon (Ne), a common gas, e.g. nitrogen (N), hydrogen (H), mercury (Hg) vapour, or a mixture of any of these gases. When a sufficient voltage is applied between any of the electrodes, a gas discharge is developed and a plasma is generated, i.e. electrons gain energy, and ionise and excite neutral gas atoms. The plasma includes electrons, ions and metastable particles. These particles are continuously recombining, regenerating and colliding. The collision of an energetic electron with a gas atom may produce a high energy state in the electron shell of the gas atom, which decays to a lower energy state under emission of energetic radiation. The gas and the operating parameters, such as applied voltage, may be chosen to be such that the radiation is within the ultraviolet (UV) spectrum. This UV light is thereafter used to excite fluorescent substances of the fluorescent screen. Visible light, such as red, green and blue light, is then emitted by these excited substances.

The UV radiation is used instead of the kinetic energy of the plasma electrons because direct excitation of the fluorescent substances by the plasma electrons does not generate enough light due to the low electron energies present in a plasma.

However, the conversion of discharge energy to UV light, and conversion of UV light to visible light are not very efficient. In a PDP with He—Xe or Ne—Xe, only about 2% of the electric energy is used in UV light and about 0.2% is used in visible light (Applied Physics, vol 51, no 3, 1982, pp 344-347; Optical Techniques Contact, vol 34, no 1, 1996, p 25; and Flat Panel Display 96, parts 5-3, NHK Techniques Study, 31-1, 1979, page 18). Thus, it would be desirable to improve the luminous efficacy of PDPs. Hence, the luminance performance, such as brightness, would then be improved.

To generate a higher luminous efficacy, it has been proposed to extract the electrons generated in the plasma through holes in the anode and subsequently accelerate them to a higher energy. Such gas discharge displays are known from U.S. Pat. No. 3,938,135.

Displays in which a light-emitting material is directly excited by electron bombardment are known in general terms as cathodoluminescent displays.

In the known cathodoluminescent gas discharge display, the cathode is placed at the back of the device and put at a negative voltage as compared to the anode grid, which is arranged at the front of the device. The voltage across the anode and the cathode generates a plasma comprising electrons and ions, wherein the electron flow is directed to the anode and the ion flow is directed to the cathode.

In a plasma, new electrons and ions are generated, as disclosed above, by ionisations of neutral gas atoms by energetic electrons, which gain their energy by the applied voltage. Furthermore, new electron generation at the cathode is necessary to sustain the plasma. Plasma ions hitting the cathode generate these secondary electrons.

The electrons which are generated in the plasma reach the anode and a fraction of them passes through holes in the anode grid and is subsequently accelerated to a screen comprising a luminescent substance, such as a phosphor.

Basically, three regions are comprised in a cathodoluminescent gas discharge display; (1) a plasma region, (2) a selection region, and (3) an acceleration region.

In the plasma region, the plasma is generated as described above.

In the selection region, the display content can be controlled by applying voltages to selection grids that can inhibit the electrons from reaching the phosphor screen.

In the acceleration region, the electrons are accelerated by an applied acceleration voltage to a higher kinetic energy.

Due to practical aspects, the gas pressure is equal in all of the three regions.

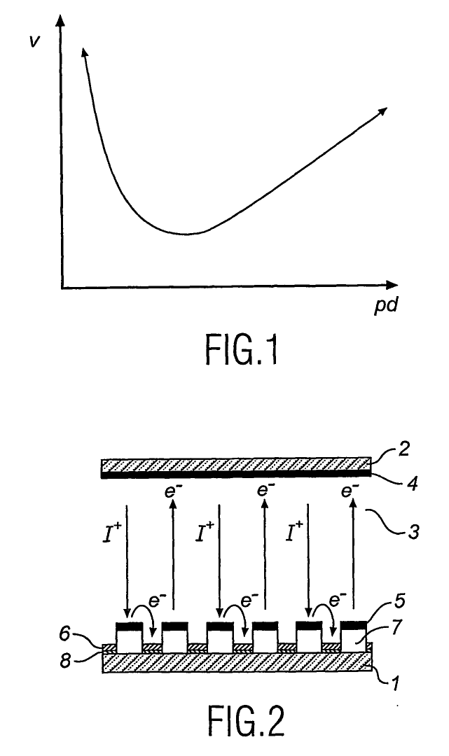

The so-called Paschen curve shows the dependence of the firing voltage (V) of a plasma as a function of the product of the gas pressure multiplied with the electrode distance (pd), see FIG. 1.

The firing voltage is the voltage needed to generate a plasma, i.e. the voltage needed to create enough ions by electrons starting from the cathode travelling to the anode. The created ions travel to the cathode and have to generate as many electrons, by secondary electron emission when they strike the cathode, as originally started.

The sustain voltage is the voltage needed to keep a plasma alive. This voltage is generally lower than the firing voltage because once a plasma exists, space charge is present. This space charge causes a non-homogenous electric field which can lower the voltage needed to ionise gas atoms.

The minimum of the curve in FIG. 1 is desirable for the plasma region, i.e. a plasma starts at a low voltage, which is favourable for the driving electronics of the device. Thus, if a low pressure is to be used, the plasma region is made relatively long to get the desirable product of gas pressure multiplied with the electrode distance.

The left side of the curve is desirable for the acceleration region, i.e. as few ionisations as possible should occur because the electrons lose energy if they ionise and, depending on the position of creation, newly created electrons can only gain a portion of the energy. Generation of new electrons therefore means that the average electron energy decreases. Thus, the acceleration region is made relatively short to get a small product of gas pressure multiplied with the electrode distance.

If too many ionisations occur in the acceleration region, a self-sustaining secondary plasma can be generated in this region, which means that the display content cannot be controlled. Furthermore, if ionisations occur in the acceleration region, the generated ions can enter the plasma region through the holes in the anode. Depending on the applied voltages, this way cause a feedback into the plasma region which may result in disadvantageous plasma contractions. A plasma contraction means that much more current will start to flow locally at one point because the extra ions from the acceleration region may change the space charge near the anode and may also cause more electrons to be created from ionisations and secondary emission. Consequently, the acceleration voltage that can be applied is limited to a rather low value, which results in a display device, such as the display device having a poor luminous efficacy, known from the cited U.S. Pat. No. 3,938,135.

It is an object of the present invention to provide a cathodoluminescent gas discharge display having an improved luminous efficacy.

According to a first aspect of the invention, this object is achieved with a cathodoluminescent gas discharge display which comprises a defined, gas-filled space, anode and cathode means adapted to receive an electrical voltage, and a luminescent screen comprising a luminescent substance. When an electrical voltage is applied across the anode and the cathode, a plasma comprising ions and electrons is generated by a gas discharge in the gas-filled space, said plasma ions impact on the cathode, and secondary electrons are created by said impact. The anode is provided in a rear section of the display, while the cathode and the luminescent screen are provided in a front section of the display, and said secondary electrons are used to excite the luminescent substance.

Thus, the electrons generated in the plasma flow to the anode in the rear section of the display and these electrons are consequently not used to excite the luminescent substances. The ions generated in the plasma flow to the cathode and secondary electrons are created by the impact of these plasma ions on the cathode. Some of these secondary electrons are used to excite the luminescent substances of the screen. Residual secondary electrons are used to sustain the plasma.

An advantage of the invention is that the above disclosed feedback problems are reduced, implying the application of a higher acceleration voltage as compared to the above-disclosed prior art cathodoluminescent gas discharge display. Use of a higher acceleration voltage causes high-energetic electrons and yields an improved luminous efficacy. Consequently, the overall power consumption may be reduced.

Other features and advantages of the present invention will become apparent from the embodiments described hereinafter and the appended claims.

FIG. 1 shows the well-known Paschen curve.

FIG. 2 schematically shows a cathodoluminescent gas discharge display according to an embodiment of the invention.

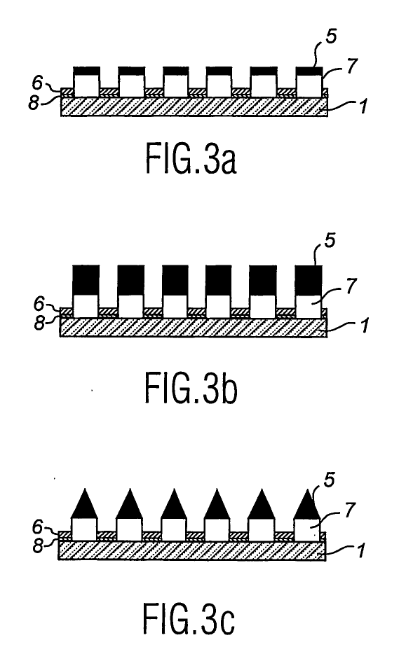

FIG. 3 shows examples of some configurations of a cathode grid which might be used in the cathodoluminescent gas discharge display shown in FIG. 2.

A part of a cathodoluminescent gas discharge display according to an embodiment of the invention is shown in FIG. 2. A front glass panel 1, a rear glass panel 2, and side-walls (not shown in FIG. 2) define a gas-filled space 3.

Furthermore, an internal or external vacuum support (not shown in FIG. 2) is provided.

An anode 4 is arranged in the rear section of the display. In this embodiment, the anode 4 is disposed on the side of the rear panel 2 facing the gas-filled space 3.

A cathode grid 5 and a luminescent screen 6 are arranged in the front section of the display. In this embodiment, the cathode grid 5 and phosphor elements 6 are disposed on the side of the front panel 1 facing the gas-filled space 3.

The luminescent screen 6 is preferably a phosphor screen.

In this embodiment of the invention the anode 4 is made of a metal, such as aluminium (Al), but could also be made of any other conducting material, such as indium tin oxide (ITO).

The cathode grid 5 is made of a conducting material. The conducting material is preferably either coated with a high secondary electron emitting material or is a high secondary electron emitting material itself.

A material having a high secondary electron coefficient (a high secondary electron emitting material) emits a large amount of secondary electrons during the impact of positive ions.

Aluminium is a suitable conducting material which, upon exposure to air, forms a surface layer of aluminium oxide. This oxide has a relatively high secondary electron coefficient.

Another example of a suitable cathode material is an alloy of aluminium and magnesium. Upon exposure to air, such an alloy may form a surface layer of magnesium oxide, which also has a relatively high secondary electron coefficient.

Another material having a high secondary electron coefficient is lanthanum boron (LaB₆).

The cathode grid 5 is applied on spacer elements 7 made of glass, which in turn is applied on the front glass panel 1.

The spacer elements should be made of an insulating and vacuum compatible material, such as glass, Al₂O₃, or a ceramic material. This material is preferably coated with a low secondary electron emitting material, such as CrO₃ or Si₃N₄, in order to prevent charging and thereby enhancing the electric field which might otherwise cause field emission to occur.

The distances between the spacer elements are preferably one sub-pixel each.

Phosphor 6 is provided on the front glass panel 1 between the spacer elements 7.

A discharge gas of neon (Ne) having a pressure of 0.97 mbar is provided in the middle section of the panel forming said gas-filled space 3 and constituting the plasma region. The gas pressure should preferably be within the range of from 0.1 to 10 mbar, more preferably within the range of from 0.5 to 5 mbar.

The plasma region in this embodiment is about 20 mm, but the length of the plasma region could be adjusted in relation to desired operating parameters.

When an electrical voltage is applied across the anode 4 and the cathode 5, a plasma comprising electrons (e⁻) and ions (I⁺) is generated. The plasma electrons (e⁻) will go from the cathode grid 5 to the anode 4 in the rear section, and the ions (I⁺) will go in the opposite direction, i.e. from the place of ionisation to the cathode grid 5. Thus, electrons (e⁻) generated in the plasma will not reach the phosphor screen 6. However, some of the secondary electrons (e⁻) created by the impact of plasma ions (I⁺) on the cathode grid 5 are captured by the electric field penetrating through the holes of the cathode grid 5. These secondary electrons (e⁻) are passed through the holes of the cathode grid 5 and accelerated by an acceleration electrode 8 forming an acceleration region. The secondary electrons (e⁻) which are not captured by said electric field are used to sustain the plasma.

In this embodiment, the acceleration electrode 8 is formed by a layer 8 of indium tin oxide (ITO) applied on the glass panel 1.

In this embodiment, the acceleration region is about 1 mm, but the length of the acceleration region could be adjusted in relation to desired operating parameters.

An acceleration voltage of at least 1 kV, more preferably at least 5 kV, such as 5-15 kV, is preferably applied.

As described in the introduction, the acceleration voltage should preferably be as high as possible to decrease the amount of current needed. Moreover, a high acceleration voltage also means fewer ionisations in the acceleration region and consequently less sputtering of the materials, such as the cathode material, in the device. In addition, the phosphor will exhibit a longer life time.

Some of the positive plasma ions might also pass through the holes of the cathode grid 5 and generate secondary electrons at the other side of the grid 5. These electrons are also accelerated to the phosphor screen 6.

Another advantage when said positive plasma ions penetrate into the acceleration region is that wall charging effects might be reduced. Thus, a different space charge distribution is provided. Hence, the firing voltage of the acceleration region is improved.

Even if ions that might be generated in the acceleration region may pass through the holes of the cathode grid 5, they will not influence the plasma so much, because they are directed to the cathode grid 5. Thus, said problems of feedback and plasma contraction are considerably reduced.

The thickness of the cathode grid 5 may be within the range of from 100 nm to 100 μm. The grid shape may also be varied as shown, for example, in FIG. 3. The thickness and shape of the cathode grid 5 may be chosen in order to tune the ratio of secondary electrons going to the screen 6 and to the anode 4, respectively. The part of the secondary electrons going to the anode 4 contributes to sustaining the plasma.

The use of a thicker cathode grid 5, i.e. about 100 μm, means that a higher ratio of secondary electrons may reach the screen 6 than if a thinner cathode grid 5 is used.

The use of a cone-shaped cathode grid 5 as shown in FIG. 3c might also increase the amount of electrons reaching the phosphor screen 6.

In the embodiment of the invention described herein, only one grid is used, which means that the cathode 5 and the anode 4 need to be structured row and columnwise.

However, two or more grids might also be used, which means that a plasma can exist in the whole row, or in multiple rows, at a time. Even the entire plasma region may be filled with a plasma.

A non-structured anode and a non-structured cathode may also be used in combination with at least one selection grid.

The invention will now be further illustrated by means of the following non-limiting example.

### REFERENCE EXAMPLE

A cathodoluminescent gas discharge display having a cathode in the rear section, and an anode grid and a phosphor screen in the front section was used as a reference. 0.97 mbar Ne was used as discharge gas.

A voltage was applied across the cathode (−400 V) and the anode (0 V). A screen current of 0.2 mA and a plasma current of 0.2 mA were used. Only 200 V could be applied across the acceleration region before bright, orange spots were formed in the display image.

### EXAMPLE

The cathodoluminescent gas discharge display shown in FIG. 2 was used in this example.

A voltage was applied across the anode 4 (+400 V) and the cathode 5 (0 V). A screen current of 0.2 mA and a plasma current of 0.2 mA were first applied. However, the plasma current had to be increased to 2 mA in order to retain the same screen current, 0.2 mA. Only a fraction of the plasma current will reach the luminescent screen 6 and provide the screen current. This fraction is a function of the secondary electron emission coefficient of the material of the cathode 5 or the material covering the cathode 5 (as described above).

When more electrons are created per ion, fewer ionisations and hence current are needed in the plasma region. Thus, the ratio between screen current and plasma current may be increased, using a cathode 5 made of or coated with a high secondary electron emitting material.

About 2 kV was applied across the acceleration region. Thus, the secondary electrons were accelerated to a very high kinetic energy and an improved phosphor efficacy was obtained. Hence, an improved luminance performance is provided and less current is needed to get the same luminance as provided with the above disclosed prior art cathodoluminescent gas discharge display.

From the above disclosure, it can be concluded that the cathodoluminescent gas discharge display according to the present invention will find a range of applications because it is easy to produce, at low cost, has a high luminous efficacy and yields high quality images.

1. A cathodoluminescent gas discharge display comprising a defined, gas-filled space (3), an anode (4) and a cathode (5) adapted to receive an electrical voltage, and a luminescent screen comprising a luminescent substance (6), wherein, when an electrical voltage is applied across the anode (4) and the cathode (5), a plasma comprising ions and electrons is generated by a gas discharge in the gas-filled space (3), said plasma ions impact on the cathode (5), and secondary electrons are created by said impact, characterized in that
the anode (4) is provided in a rear section of the display,
the cathode (5) and the luminescent screen (6) are provided in a front section of the display, and
said secondary electrons are used to excite the luminescent substance (6).

2. A cathodoluminescent gas discharge display as claimed in claim 1, wherein the secondary electrons are accelerated from the cathode (5) to the screen (6) by an applied acceleration voltage.

3. A cathodoluminescent gas discharge display as claimed in claim 2, wherein the acceleration voltage is at least 1 kV.

4. A cathodoluminescent gas discharge display as claimed in any one of claims 1 to 3, wherein the screen comprising a luminescent substance (6) is a phosphor screen.

5. A cathodoluminescent gas discharge display as claimed in any one of claims 1 to 4, wherein the cathode (5) is made of or coated with a high secondary electron emitting material.

6. A cathodoluminescent gas discharge display as claimed in any one of claims 1 to 5, wherein the cathode (5) thickness is within the range of from 100 nm to 100 μm.

7. A cathodoluminescent gas discharge display as claimed in any one of claims 1 to 6, wherein the cathode (5) is cone-shaped.
